(19) United States
(12) Patent Application Publication
(10) Pub. No.: US 2006/0073295 A1
(43) Pub. Date: Apr. 6, 2006

(54) Bottle cork with reduced trichloroanisole release and method for its production

(75) Inventor: Klaus Angermaier, Munchen (DE)

Correspondence Address: BROOKS KUSHMAN P.C., 1000 TOWN CENTER, TWENTY-SECOND FLOOR, SOUTHFIELD, MI, 48075, US

(73) Assignee: Wacker-Chemie GmbH, Munich (DE)

(21) Appl. No.: 11/236,027

(22) Filed: Sep. 27, 2005

(30) Foreign Application Priority Data
Sep. 30, 2004 (DE) 10 2004 047 709.4

(51) Int. Cl. B65D 39/00; B32B 27/08

(52) U.S. Cl. 428/35.7; 215/355; 220/801; 428/66.3

(57) ABSTRACT

The invention relates to a cork-containing bottle stopper with a surface which is provided with a coating of an elastomer, wherein the elastomer comprises α-, β-, or γ-cyclodextrin or α-, β-, or γ-cyclodextrin derivative.

### BACKGROUND OF THE INVENTION

1. Field of the Invention

The invention relates to a bottle cork with reduced trichloroanisole release and to a method for its production.

2. Background Art

The cork taste of wine is a result of the halogen-containing, low molecular weight aromatics produced by molds, the best known being the musty-smelling extremely odor-intensive 2,4,6-trichloroanisole. In EP 0 210 261 A, bottle corks are impregnated with a two-component silicone rubber in a vacuum process. This process is designed to provide corks of lower quality with improved sealing properties, and to reduce the extraction of aromatic cork constituents which impair the taste of the beverage, such as trichloroanisole, and to thereby increase the value of the cork. In EP 1 135 301 B1, bottle corks are provided on the side facing the beverages with a layer of silicone elastomer which is said to suppress the migration of trichloroanisole from the bottle cork into the beverage. The disadvantage of these bottle corks is that the silicone elastomer readily absorbs low molecular weight aromatic compounds and can thus not act as a barrier for such substances. Rather, the effect of the process described in the literature is based on the fact that for the aromatic compounds a chemical equilibrium is established between the silicone elastomer and liquid phases in which some of the aromatic compound is permanently absorbed within the silicone.

DE 10 147 626 A1 discloses a method of impregnating bottle corks in which the bottle corks are impregnated with silicone rubber masses which are crosslinkable to give elastomers and which contain organopolysiloxanes having 1.0 to 2.0% by weight of Si-bonded hydrogen. These bottle corks too still have the abovementioned disadvantage, however.

### SUMMARY OF THE INVENTION

An object of the invention was to provide a cork-containing bottle cork which has reduced trichloroanisole release. These and other objects are achieved by providing at least one surface of the bottle cork with a coating of an elastomer, wherein the elastomer contains an α-, β- or γ-cyclodextrin, or an α, β- or γ-cyclodextrin derivative, preferably uncomplexed.

### DETAILED DESCRIPTION OF THE PREFERRED EMBODIMENT(S)

Cork-containing bottle corks are preferably understood as meaning stoppers made of cork for closing beverage bottles, such as, for example, wine bottles.

The α-, β- or γ-cyclodextrin or an α-, β- or γ-cyclodextrin derivative may be any cyclodextrin or derivative, and may also be a mixture of such substances. Preferably, the cyclodextrin is α-, β- or γ-cyclodextrin or a α-, β- or γ-cyclodextrin derivative chosen from the group of alkylated, hydroxyalkylated, acylated and sulfoalkyl ether-substituted α-, β- or γ-cyclodextrins. Preference is given to the nonderivatized α-, β- or γ-cyclodextrins, in particular γ-cyclodextrin. In the text below, the term cyclodextrin (CD) also includes cyclodextrin derivatives.

The elastomer preferably contains 0.01 to 40% by weight of CD, preferably 10 to 25% by weight, the percentage by weight based on the total weight of the elastomer. As a result of the context of uncomplexed CD in the elastomer, a significantly larger proportion of trichloroanisole is absorbed than is known from the prior art.

In principle, any elastomer which comprises CD capable of complexing with trichloroanisole and/or like compounds is suitable as a coating for a cork. A CD-containing elastomer is obtainable by incorporating CD into the elastomer. This can be carried out before, during or after the preparation of the elastomer, depending on the type of elastomer. Preferably, the CD is totally uncomplexed, and is incorporated by conventional techniques which are used for incorporating fillers into elastomers.

The elastomer into which the CD is incorporated is preferably obtainable from a crosslinkable silicone rubber composition comprising
(1) organopolysiloxanes which have radicals with aliphatic carbon-carbon multiple bonds,
(2) organopolysiloxanes with Si-bonded hydrogen atoms,
(3) catalysts which promote the addition of Si-bonded hydrogen onto aliphatic multiple bonds and optionally
(4) agents, so-called inhibitors, which delay or inhibit the addition of Si-bonded hydrogen onto aliphatic multiple bonds, or
(5) organopolysiloxanes which have radicals with aliphatic carbon-carbon multiple bonds, and
(6) peroxides promoting the free-radical crosslinking of aliphatic multiple and single bonds, or
(7) organopolysiloxanes which have radicals with hydroxyl groups,
(8) as crosslinkers, siloxanes with Si-bonded, hydrolyzable groups, and
(9) catalysts promoting the hydrolysis of these groups with the formation of Si—O—Si bridges.

The organopolysiloxanes used according to the invention are standard commercial products or can be produced by methods customary in silicon chemistry.

The organopolysiloxanes (1) are preferably linear or branched organopolysiloxanes comprising units of the general formula

$${R}_{a} {R}_{b}^{1} {SiO}_{\frac{4 - a - b}{2}} , \qquad ( I )$$

where each R is identical or different, and is a monovalent, optionally substituted hydrocarbon radical having 1 to 18 carbon atom(s) per radical and each R¹ is identical or different, and is a monovalent hydrocarbon radical with a terminal, aliphatic carbon-carbon multiple bond having 2 to 8 carbon atoms per radical,
a is 0, 1, 2 or 3,
b is 0, 1 or 2
and the sum a+b is <3,
with the proviso that the organopolysiloxanes of the formula (I) comprise at least 2 radicals R¹ per molecule.

R is preferably a hydrocarbon radical free from aliphatic carbon-carbon multiple bonds. Examples of radicals R are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; cycloalkyl radicals such as the cyclopentyl, cyclohexyl, cycloheptyl and methylcyclohexyl radicals; aryl radicals such as the phenyl, naphthyl, anthryl and phenanthryl radicals; alkaryl radicals such as the o-, —, and p-tolyl radicals, xylyl radicals and ethylphenyl radicals; and aralkyl radicals such as the benzyl radial, and the α- and the β-phenylethyl radicals. Examples of substituted radicals R are haloalkyl radicals such as the 3,3,3-trifluoro-n-propyl radical, the 2,2,2,2′,2′,2′-hexafluoroisopropyl radical, the heptafluoroisopropyl radical, and haloaryl radicals such as the o-, — and p-chlorophenyl radicals. Preferably, the radical R is a monovalent hydrocarbon radical having 1 to 6 carbon atoms, with the methyl radical being particularly preferred.

Examples of radicals R¹ are alkenyl radicals such as the vinyl, 5-hexenyl, cyclohexenyl, 1-propenyl, allyl, 3-butenyl and 4-pentenyl radicals, and alkynyl radicals such as the ethynyl, propargyl and 1-propynyl radicals. Preferably, the radical R¹ is an alkenyl radical, with the vinyl radical being particularly preferred.

It is possible to use one type of organopolysiloxane (1) or different types of organopolysiloxanes (1). Preferred organopolysiloxanes (1) are those of the general formula
R¹_{g}R_{3-g}SiO(SiR₂O)ₙ(SiRR¹O)ₘSiR_{3-g}R¹_{g} (II)
where R and R¹ have the meaning given for them above,
g is 0, 1, 2 or 3, preferably 1,
m is 0 or an integer from 1 to 5000 and
n is an integer from 70 to 10,000,
with the proviso that the organopolysiloxanes of the formula (II) comprise at least two radicals R¹ per molecule.

For the purposes of this invention, formula (II) is to be understood such that n units —(SiR₂O)— and m units (SiRR₁O)— can be distributed within the organopolysiloxane molecule in any way, for example as blocks or randomly.

The organopolysiloxanes (1) preferably have an average viscosity of from 100 to 100,000,000 mPa.s at 25° C.

The crosslinkers used for the addition crosslinking of the silicone rubber compositions according to the invention are organopolysiloxanes (2). The organopolysiloxanes (2) are preferably linear, cyclic or branched organopolysiloxanes containing units of the general formula

$${R}_{e} {H}_{f} {SiO}_{\frac{4 - e - f}{2}} , \qquad ( III )$$

where
R has the meaning given for it above,
e is 0, 1, 2 or 3,
f is 0, 1 or 2
and the sum of e+f is <3,
with the proviso that the organopolysiloxanes of the formula (III) have 1.0 to 2.0% by weight of Si-bonded hydrogen.

Preferred organopolysiloxanes (2) are those of the general formula
HₕR₃₋ₕSiO(SiR₂O)ₒ(SiR₂₋ₓHₓO)ₚSiR₃₋ₕHₕ (IV)
where R has the meaning given for it above,
h is 0, 1 or 2, preferably 0,
o is 0 or an integer from 1 to 1000, preferably 0,
p is an integer from 1 to 1000, preferably 40 to 70 and
x is 1 or 2, preferably 1,
with the proviso that the organopolysiloxanes of the formula (IV) have 1.0 to 2.0% by weight, preferably 1.5 to 1.7% by weight, of Si-bonded hydrogen.

For the purposes of this invention, formula (W) should be understood such that o units —(SiR₂O)— and p units —(SiR₂₋ₓHₓO)— can be distributed within the organopolysiloxane molecule in any way, for example as blocks or randomly.

Examples of organopolysiloxanes (2) are, in particular, copolymers of dimethylhydrogensiloxane, methylhydrogensiloxane, dimethylsiloxane and trimethylsiloxane units; copolymers of trimethylsiloxane, dimethylhydrogensiloxane and methylhydrogensiloxane units; copolymers of trimethylsiloxane, dimethylsiloxane and methylhydrogensiloxane units; copolymers of methylhydrogensiloxane and trimethylsiloxane units; copolymers of methylhydrogensiloxane, diphenylsiloxane and trimethylsiloxane units; copolymers of methylhydrogensiloxane, dimethylhydrogensiloxane and diphenylsiloxane units; copolymers of methylhydrogensiloxane, phenylmethylsiloxane, trimethylsiloxane and/or dimethylhydrogensiloxane units; copolymers of methylhydrogensiloxane, dimethylsiloxane, diphenylsiloxane, trimethylsiloxane and/or dimethylhydrogensiloxane units; and copolymers of dimethylhydrogensiloxane, trimethylsiloxane, phenylhydrogensiloxane, dimethylsiloxane and/or phenylmethylsiloxane units.

It is possible to use one type of organopolysiloxane (2) or different types of organopolysiloxanes (2). The organopolysiloxanes (2) preferably have an average viscosity of from 10 to 100,000 mPa.s at 25° C., more preferably 10 to 500 mPa.s at 25° C., and most preferably 10 to 30 mPa.s at 25° C. Besides the organopolysiloxanes (2) rich in Si-bonded hydrogen, the compositions according to the invention can also comprise organopolysiloxanes (2′) of the general formula
HᵥR₃₋ᵥSiO(SiR₂O)ₛ(SiRHO)ₜSiR₃₋ᵥHᵥ (IV′)
where R has the meaning given for it above,
v is 0, 1 or 2,
s is 0 or an integer from 1 to 1000,
t is 0 or an integer from 1 to 1000,
with the proviso that the organopolysiloxanes of the formula (IV′) comprise at least 2 Si-bonded hydrogen atoms per molecule but less than 1.0% by weight of Si-bonded hydrogen. Where v=1 and t=0 in formula (IV′), these are, for example, α,ω-dihydrogenorganopolysiloxanes, which act, for example, as chain extenders. The organopolysiloxanes (2′) preferably have an average viscosity of from 10 to 100,000 mPa.s at 25° C., more preferably 10 to 500 mPa.s at 25° C. Organopolysiloxane (2) is preferably used in the silicone rubber compositions in amounts of from 0.01 to 20% by weight, based on the total weight of the organopolysiloxanes (1), and organopolysiloxane (2′) is preferably used in the silicone rubber compositions in amounts of from 0 to 100% by weight, based on the total weight of the organopolysiloxanes (1).

Catalysts (3) which promote the addition of Si-bonded hydrogen onto aliphatic multiple bonds which may be used in the silicone rubber compositions, and which are commonly termed “hydrosilylation catalysts,” are any catalysts which are useful for promoting the addition of Si-bonded hydrogen onto aliphatic multiple bonds. The catalysts are preferably a metal from the platinum group of metals or a compound or a complex of a metal from the platinum group of metals. Examples of such catalysts are metallic and finely divided platinum, which can also be deposited on supports such as silicon dioxide, aluminum oxide or activated carbon, compounds or complexes of platinum, such as platinum halides, e.g. PtCl₄, H₂PtCl₆.6H₂O, Na₂PtCl₄.4H₂O, platinum-olefin complexes; platinum-alcohol complexes; platinum-alkoxide complexes; platinum-ether complexes; platinum-aldehyde complexes; platinum-ketone complexes, including reaction products of H₂PtCl₆.6H₂O and cyclohexanone; platinum-vinyl-siloxane complexes such as platinum 1,3-divinyl-1,1,3,3-tetramethyldisiloxane complexes with or without a content of detectable inorganically bound halogen; bis(gamma-picoline)platinum dichloride; trimethylenedipyridineplatinum dichloride; dicyclopentadieneplatinum dichloride; dimethylsulfoxideethyleneplatinum(II) dichloride; cyclooctadieneplatinum dichloride; norbornadieneplatinum dichloride; gamma-picolineplatinum dichloride; cyclopentadieneplatinum dichloride; and also reaction products of platinum tetrachloride with olefin and primary amine or secondary amine or with primary and secondary amine, such as the reaction product of platinum tetrachloride dissolved in 1-octene with sec-butylamine, or ammonium-platinum complexes.

The catalyst (3) is preferably used in the silicone rubber compositions in amounts of from 0.001 to 0.1% by weight, in each case calculated as elemental platinum and based on the total weight of the organopolysiloxanes (1) and (2).

Inhibitors (4) which can be used in the silicone rubber masses according to the invention include all inhibitors which inhibit the addition of Si-bonded hydrogen to diphatic multiple bonds, and are preferably used in amounts of from 0.001 to 10% by weight, based on the total weight of the organopolysiloxanes (1) and (2). Examples of inhibitors (4) are 1,3-divinyl-1,1,3,3-tetramethyldisiloxane, benzotriazole, dialkylformamides, alkylthioureas, methyl ethyl ketoxime, organic or organosilicon compounds with a boiling point of at least 25° C. at 1012 mbar (abs.) and at least one aliphatic triple bond, such as 1-ethynylcyclohexan-1-ol, 2-methyl-3-butyn-2-ol, 3-methyl-1-pentyn-3-ol, 2,5-dimethyl-3-hexen-2,5-diol and 3,5-dimethyl-1-hexyn-3-ol, 3,7-dimethyloct-1-yn-6-en-3-ol, a mixture of diallyl maleate and vinyl acetate, maleate monoesters, and inhibitors such as the compound of the formula HC═C—C(CH₃)(OH)—CH₂—CH₂—CH═C(CH₃)₂, commercially available under the trade name “Dehydrolinalool” from BASF.

For the organopolysiloxanes (5) and their preferred and particularly preferred embodiments, and examples, the corresponding descriptions of the organopolysiloxanes (1) apply.

Peroxides (6) are organic peroxides which serve as a source of free radicals. A single type of organic peroxide or a mixture of at least two different types of organic peroxides may be used, preferably in amounts of from 0.01 to 5.0% by weight, more preferably 0.2 to 1.2% by weight, in each case based on the total weight of the diorganopolysiloxanes. Examples of organic peroxides are acyl peroxides, such as dibenzoyl peroxide, bis(4-chlorobenzoyl)peroxide, bis(2,4-dichlorobenzoyl)peroxide and bis(4-methylbenzoyl)peroxide; alkyl peroxides and aryl peroxides, such as di-tert-butyl peroxide, 2,5-bis(tert-butylperoxy)-2,5-dimethylhexane, dicumyl peroxide and 1,3-bis(tert-butylperoxyisopropyl)benzene; perketals, such as 1,1-bis(tert-butylperoxy)-3,3,5-trimethylcyclohexane; peresters, such as diacetyl peroxydicarbonate, tert-butyl perbenzoate, tert-butyl peroxyisopropylcarbonate, tert-butyl peroxyisononanoate, dicyclohexyl peroxydicarbonate and 2,5-dimethylhexane 2,5-diperbenzoate.

The organopolysiloxanes (7) are preferably those of the general formula
XR₂SiO(R₂SiO)ₙSiR₂X (V)
where each R is an identical or different, monovalent, optionally substituted hydrocarbon radical having 1 to 18 carbon atoms per radical,
X is a hydroxyl group and
n is an integer of at least 10.

The hydroxyl groups X in formula (V) may, if desired, be completely or partially replaced by other condensable groups, such as alkoxy groups having 1 to 4 carbon atoms per group.

In addition to the diorganosiloxane units R₂SiO, other siloxane units may also be present within and/or along the siloxane chain of the organopolysiloxanes of the formula (V) given above, which is conventionally not represented by such formulae. Examples of such other siloxane units present, mostly only as impurities are those of the formulae RSiO_{3/2}, R₃SiO_{1/2} and SiO_{4/2}, where R has the meaning given for it above.

It is possible to use one type of organopolysiloxane or two or more types of organopolysiloxanes. The organopolysiloxanes preferably have a viscosity of from 50 to 80,000 mPa.s at 25° C., more preferably 1000 to 20,000 mPa.s at 25° C.

The crosslinkers (8) are preferably moisture-sensitive silanes of the general formula
RₓSiZ₄₋ₓ
and/or partial hydrolysates thereof which preferably have 2 to 10 silicon atoms,
where R has the meaning given for it above,
x is 0 or 1 and
Z each are identical or different hydrolyzable radicals chosen from the group of acyloxy, optionally substituted hydrocarbonoxy, amino, oxime, amide, amineoxy and eneoxy radicals.

The Z radicals are preferably

| | |
|---|---|
| acyloxy groups | —OCOR, |
| optionally substituted hydrocarbonoxy groups | —OR³, |
| amino groups | NR⁴₂, |
| oxime groups | —ON═A, |
| amide groups | 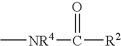 |
| amineoxy groups | —O—NR⁴₂, and |
| eneoxy groups | —O—C(R²)═C—R⁴ |

where R² is a monovalent hydrocarbon radical having 1 to 12 carbon atoms,
R³ is a monovalent hydrocarbon radical having 1 to 4 carbon atoms,
R⁴ is hydrogen or an identical or different, monovalent hydrocarbon radical having 1 to 12 carbon atoms and
A is an identical or different radical of the formula
   R⁵₂═C or R⁶C═,
where R⁵ is identical or different, monovalent hydrocarbon radicals having 1 to 5 carbon atoms per radical and R⁶ is a divalent hydrocarbon radical having 5 or 6 carbon atoms per radical.

Examples of acyloxy groups are acetoxy, formyloxy groups and 2-ethylhexanoxy groups. Examples of hydrocarbonoxy groups are methoxy, ethoxy, n-propyloxy, isopropyloxy, and n-butyloxy groups. Examples of substituted hydrocarbonoxy groups are hydrocarbonoxy groups substituted by alkoxy groups, such as methoxyethyleneeoxy, ethoxyethyleneoxy and methoxyisopropyleneoxy groups. Examples of amino groups are n-butylamino, sec-butylamino and cyclohexylamino groups.

Examples of oxime groups are methyl ethyl ketoxime groups, methyl isobutyl ketoxime groups, methyl n-amyl ketoxime groups and dimethyl ketoxime groups. Examples of amide groups are n-methylbenzamido groups and n-methylacetamido groups. An example of an amineoxy group is the hydroxylamine group. An example of an eneoxy group is the isopreneoxy group.

For the crosslinking of condensation-crosslinking 2-component compositions, the curing component is mixed in directly prior to use. This curing component is preferably a tetraalkoxysilane, preferably tetraethyl or tetrapropyl silicate.

As catalyst (9), any condensation catalyst which promotes the condensation reaction may be used.

Examples of condensation catalysts are butyl titanates and organic tin compounds such as di-n-butyltin diacetate, di-n-butyltin dilaurate and reaction products of, per molecule, at least two monovalent hydrocarbon radicals bonded to silicon via oxygen and optionally substituted by an alkoxy group as a silane having hydrolyzable groups or oligomer thereof with diorganotin diacylate where, in these reaction products, all valencies of the tin atoms are saturated by oxygen atoms of the group
≡SiOSn≡
or by SnC-bonded, monovalent organic radicals. The preparation of such reaction products is described in detail in U.S. Pat. No. 4,460,761 (Jul. 17, 1984, A. Schiller et al., Wacker-Chemie GmbH).

The silicone rubber compositions can comprise further constituents, such as fillers (10), which may include reinforcing and non-reinforcing fillers and resin-like organopolysiloxanes such as MQ resins (11).

Examples of reinforcing fillers (11a), i.e. fillers with a BET surface area of at least 50 m²/g, are fumed silicas, precipitated silicas or silicon-aluminum mixed oxides with a BET surface area of more than 50 m²/g. The specified fillers may be hydrophobicized, for example by treatment with organosilanes, organosilazanes, or organosiloxanes, or by etherification of hydroxyl groups to alkoxy groups. Preference is given to fumed silicas with a BET surface area of at least 100 m²/g. The reinforcing fillers (11a) are preferably present in amounts of from 0 to 20% by weight.

Examples of non-reinforcing fillers (11b), i.e. fillers with a BET surface area of less than 50 m²/g, are powders of quartz, cristobalite, diatomaceous earth, calcium silicate, zirconium silicate, montmorillonites such as bentonites, zeolites (including molecular sieves) such as sodium aluminum silicate, metal oxides such as iron oxide, zinc oxide, titanium dioxide and aluminum oxide and mixed oxides thereof, metal hydroxides such as aluminum hydroxide, metal carbonates such as calcium carbonate, magnesium carbonate and zinc carbonate, metal sulfates such as barium sulfate, gypsum, silicon nitride, silicon carbide, boron nitride, glass powders, carbon powders, plastic powders, and glass and plastic hollow spheres.

The non-reinforcing fillers are preferably present in amounts of from 0 to 50% by weight, and it is possible to use a single type of filler, or a mixture of at least two fillers.

The resin-like organopolysiloxanes preferably comprise monofunctional (M) and trifunctional (T) and/or tetrafunctional (Q) units, optionally also difunctional (D) units. Preference is given to the so-called MQ resins (11) which consist primarily or exclusively of monofunctional and tetrafunctional units. The monofunctional units can contain, as functional groups, unsaturated hydrocarbon radicals, such as alkenyl groups or Si-bonded hydrogen. Preference is given to MQ resins (11) of units of the formulae
R⁵R₂SiO_{1/2} and SiO_{4/2}
where R⁵ is a radical R, a hydrogen atom or a radical R¹, where R and R¹ have the meanings given for them above, and the units of the formula R⁵R₂SiO_{1/2} may be identical or different.

The ratio of M units of the formula R⁵R₂SiO_{1/2} to Q units of the formula SiO_{4/2} is preferably 4:1 to 1:2. Examples of MQ resins (12a) with unsaturated M units are those of units of the formulae SiO_{4/2} and R¹R₂SiO_{1/2} and optionally R₃SiO_{1/2}, i.e. MQ resins with exclusively unsaturated M units or MQ resins with saturated and unsaturated M units, where R and R¹ have the meanings for them given above and the ratio of M units R¹R₂SiO_{1/2} and optionally R₃SiO_{1/2} to Q units SiO_{4/2} is preferably 4:1 to 1:2 and the ratio of saturated M units R₃SiO_{1/2} to unsaturated M units R¹R₂SiO_{1/2} is preferably 10:1 to 0:1. The MQ resins (12a) are preferably used in amounts of from 0 to 100% by weight, based on the total weight of the organopolysiloxanes (1).

Further examples of MQ resins (12b) with M units having Si-bonded hydrogen are those of units of the formulae SiO_{4/2} and HR₂SiO_{1/2} and optionally R₃SiO_{1/2}, i.e. MQ resins which comprise only M units with Si-bonded hydrogen, or MQ resins which comprise M units with or without Si-bonded hydrogen, which in the case of addition-crosslinking two component mixtures are preferably present in component (B), where R has the meaning given for it above and the ratio of M units HR₂SiO_{1/2} and optionally R₃SiO_{1/2} to Q units SiO_{4/2} is preferably 4:1 to 1:2 and the ratio of M units R₃SiO_{1/2} to M units HR₂SiO_{1/2} is preferably 10:1 to 0:1. The MQ resins (12b) are preferably used in amounts of from 0 to 20% by weight, based on the total weight of the organopolysiloxanes (1).

Organopolysiloxane (2) is preferably present in the crosslinkable silicone rubber composition in an amount such that the molar ratio of SiH groups in organopolysiloxane (2) to Si-bonded radical R¹ with aliphatic carbon-carbon multiple bond in organopolysiloxane (1) and MQ resin (12a) (SiHₛᵢₗₒₓₐₙₑ₍₂₎/C═Cₜₒₜₐₗ ratio) is 0.01 to 10.0, more preferably 0.1 to 2.0. The total amount of all SiH groups in the silicone rubber compositions is preferably such that the molar ratio of SiH groups in organopolysiloxane (2), (2′) and MQ resin (12b) to Si-bonded radical R¹ with aliphatic carbon-carbon multiple bond in organopolysiloxane (1) and MQ resin (12a) (SiHₜₒₜₐₗ/C═Cₜₒₜₐₗ ratio) is 1.0 to 10.0, more preferably 1.7 to 5.0.

The abovementioned mixtures may be present as one component or else as two components. CD and the other constituents (10) and (11) may be present in the case of two component mixtures in component (A) and/or (B). Preferably, the cyclodextrins or cyclodextrin derivatives are added to the silicone mixture directly prior to processing.

The invention further provides methods of producing the bottle corks of the invention.

One method comprises dipping a bottle cork into a flowable, addition-crosslinking silicone rubber composition, e.g. prepared from components CD, (1), (2), (3), (4), (10) and (11), and then removing the excess silicone rubber composition from the bottle cork and crosslinking the silicone rubber.

A further method comprises molding a high-viscosity, addition-crosslinking silicone, e.g. prepared from the components (1), (2), (3), (4), (5) and (10) or from the components (1), (5), (6) and (10), by means of press vulcanization of the silicone to give a round molded article and the molded article is fixed onto the end of a bottle cork (i.e. the end facing the beverage) using a silicone adhesive, preferably a silicone known to those skilled in the art as an acetic acid-crosslinking RTV-1 adhesive.

A further method comprises molding a paste-like, addition-crosslinking silicone, e.g. prepared from the components (1), (2), (3), (4), (10) and (11), by means of press vulcanization of the silicone to give a round molded article in an injection molding process, and this molded article is fixed onto the end of a bottle cork using a silicone adhesive, again, preferably an acetic acid-crosslinking RTV-1 composition.

A further method comprises applying a condensation-crosslinking silicone composed of two components, e.g. prepared from the components: (1), (7), (8), (9) and (10), to the end of a bottle cork facing the beverage, followed by curing and adhesion of the silicone directly on the bottle cork at room temperature.

A further method comprises a condensation-crosslinking silicone composed e.g. of one component and prepared from the components (1), (7), (8), (9) and (10), to the end of the bottle cork facing a beverage, and curing at room temperature. During this cure, the silicone adheres directly to the bottle cork.

A further method comprises rotating a cork in a closed drum and sprayed with a silicone, thereby wetting the cork on its surface, followed by curing the silicone at room temperature.

A yet further method comprises preparing a composite cork by molding a high-viscosity, addition-crosslinking silicone, e.g. prepared from components (1), (2), (3), (4), (5) and (10), or from components (1), (5), (6) and (10), together with cork pieces by means of press vulcanization, give a stopper-shaped article.

The bottle corks used are preferably standard commercial bottle corks with a weight of from preferably 2.5 to 4.0 g.

The examples below serve to further illustrate the invention.

The constituents given in Tables 1 to 9 are the compounds below, where Me=methyl radical and Vi=vinyl radical:

| | |
|---|---|
| Vi polymer 1000: | Organopolysiloxane of the formula: |
| | ViMe₂SiO(Me₂SiO)ₙSiMe₂Vi, |
| | n = 200, with a viscosity of 1000 mPa · s |
| | at 25° C.; |
| Vi polymer 7000: | Organopolysiloxane of the formula: |
| | ViMe₂SiO(Me₂SiO)ₙSiMe₂Vi, |
| | n = 450, with a viscosity of 7000 mPa · s |
| | at 25° C.; |
| Vi polymer 20,000: | Organopolysiloxane of the formula: |
| | ViMe₂SiO(Me₂SiO)ₙSiMe₂Vi, |
| | n = 600, with a viscosity of |
| | 20,000 mPa · s at 25° C.; |
| H siloxane: | Organopolysiloxane of the formula: |
| | Me₂SiO(MeHSiO)ₙSiMe₃, n = 50, |
| | with a viscosity of 1000 mPa · s at 25° C. and |
| | 1.6% by weight of Si-bonded hydrogen; |
| H 1000: | Organopolysiloxane of the formula: |
| | HMe₂SiO(Me₂SiO)ₙSiMe₂H, n = 200, |
| | with a viscosity of 1000 mPa · s at 25° C. and |
| | 0.013% by weight of Si-bonded hydrogen; |
| Crosslinker 525: | Organopolysiloxane of the formula: |
| | Me₃SiO(MeHSiO)ₘ(Me₂SiO)ₙSiMe₃, |
| | m + n = 200, |
| | min:n⁷ = 1:2, |
| | with a viscosity of 400 mPa · s |
| | at 25° C. and |
| | 0.5% by weight of Si- |
| | bonded hydrogen. |
| V polymer 1200 A: | Organopolysiloxane of the formula: |
| | ViMe₂SiO(Me₂SiO)ₙ(ViMeSiO)ₘSiMe₂Vi |
| | n + m = 5000, n:m = 1000:1, |
| | with a viscosity of 10,000,000 mPa · s at |
| | 25° C.; |
| OH polymer 20,000: | Organopolysiloxane of the formula: |
| | (OH)Me₂SiO(Me₂SiO)ₙSiMe₂(OH), n = 600, |
| | with a viscosity of 20,000 mPa · s at |
| | 25°; |
| QM-Vi resin: | Resin of units of the formula SiO_{4/2} (Q), |
| | Me₃SiO_{1/2} (M) and ViMe₂SiO_{1/2}(Mᵥ), |
| | with a ratio of Q:M:Mᵥ = 1:0.1:0.6; |
| QM-H resin: | Resin of units of the formula SiO_{4/2}(Q), |
| | Hme₂SiO_{1/2}(M_{H}), with a ratio |
| | of Q:M_{H}= 1:2 |
| Peroxide: | Dicumyl peroxide |
| | Alkoxy crosslinker: 1,2-bis(triethoxysilyl)ethane |
| ES 15: | Methyltriacetoxysilane |
| Sn catalyst: | Dibutyltin diacetate |
| Cavamax W6: | Cycloheptaamylose (α-CD), commercially |
| | available under the trade name Cavamax ® W6 |
| | from Wacker-Chemie GmbH. |
| Cavamax W7: | Cycloheptaamylose (β-CD), commercially available |
| | under the trade name Cavamax ® W7 from |
| | Wacker-Chemie GmbH. |
| Cavamax W8: | Cyclootaamylose (γ-CD), commercially |
| | available under the trade name Cavamax ® W8 |
| | from Wacker-Chemie GmbH. |
| Cavasol W6: | 2-(Hydroxypropyl)cyclohexaamylose, commercially |
| | available under the trade name |
| | Cavasol ® W6 from Wacker-Chemie GmbH. |
| Cavasol W8: | 2(Hydroxypropyl)cyclooctaamylose, commercially |
| | available under the trade name |
| | Cavasol ® W8 from Wacker-Chemie GmbH. |
| Fumed Silica: | Fumed silica with a BET surface area of 125 m²/g, |
| | commercially avaiable under the trade name |
| | WACKER-HDK ® S13 from |
| | Wacker-Chemie GmbH. |
| Metal oxides: | Mixture of various metal oxides comprising titanium |
| | dioxide and iron oxides commercially available |
| | under the trade names Kronos ® 2056 |
| | from Kronos Titan, SICOTAN ® Yellow K |
| | 1011 from BASF AG and |
| | BAYFERROX ® 610 from Bayer AG. |
| | The mixing ratio of these three |
| | substances is 10:10:1. |
| | The mixing ratio was chosen so as |
| | to achieve a color shade as similar |
| | as possible to that natural cork. |
| Inhibitor: | Ethynylcyclohexanol |
| Pt catalyst: | Solution of a platinum 1,3-divinyl-1,1,3,3- |
| | tetramethyldisiloxane complex in dimethyl |
| | polysiloxane with a platinum content in this |
| | solution of 1% by weight |

### EXAMPLES 1 TO 4

The constituents given in tables 1 to 4 are mixed and in each case a component A and B is prepared. The components A and B obtained in each case are then mixed in the ratio 1:1.

TABLE 1

| Component A | Parts by wt. | Component B | Parts by wt. |
|---|---|---|---|
| Vi polymer 20,000 | 535 | Vi polymer 20,000 | 300 |
| Vi polymer 1000 | 535 | Vi polymer 1000 | 300 |
| Fumed Silica | 30 | H 1000 | 500 |
| Pt catalyst | 4.2 | H-Siloxane | 2 |
| Inhibitor | 0.6 | | |
| Cavamax W7 | 110 | Cavamax W7 | 110 |
| cyclodextrin | | cyclodextrin | |

TABLE 2

| Component A | Parts by wt. | Component B | Parts by wt. |
|---|---|---|---|
| Vi polymer 1000 | 500 | Vi polymer 1000 | 520 |
| Fumed Silica | 30 | QM-H resin | 10 |
| Pt catalyst | 2.1 | H-Siloxane | 0.5 |
| Inhibitor | 0.4 | | |
| Cavamax W7 | 220 | Cavamax W7 | 220 |
| cyclodextrin | | cyclodextrin | |

TABLE 3

| Component A | Parts by wt. | Component B | Parts by wt. |
|---|---|---|---|
| Vi polymer 7000 | 400 | Vi polymer 7000 | 500 |
| QM-Vi resin | 100 | Metal oxides | 2 |
| Pt catalyst | 6.4 | H-Siloxane | 4 |
| Inhibitor | 1 | | |
| Cavamax W6 | 10 | Cavamax W6 | 10 |
| cyclodextrin | | cyclodextrin | |

TABLE 4

| Component A | Parts by wt. | Component B | Parts by wt. |
|---|---|---|---|
| Vi polymer 20 000 | 210 | Vi polymer 20 000 | 195 |
| Vi polymer 1000 | 725 | Vi polymer 1000 | 610 |
| QM Vi resin | 140 | QM Vi resin | 120 |
| Metal oxides | 20 | Crosslinker 525 | 162 |
| Pt catalyst | 2 | H-Siloxane | 10 |
| | | Inhibitor | 0.3 |
| Cavamax W8 | 220 | Cavamax W8 | 220 |
| cyclodextrin | | cyclodextrin | |

The two components are mixed. The cork stoppers are then dipped into this mixture and a vacuum is applied, facilitating penetration of the silicone into the cavities of the cork. After 5 to 20 minutes, the vacuum is broken and pressure is applied in order to achieve the most complete wetting possible. After relieving the superatmospheric pressure, excess silicone is removed from the surface of the cork and the silicone on the cork is cured. Curing takes place at a temperature between 20 and 200° C., preferably between 40 and 80° C.

### EXAMPLE 5

The constituents given in Table 5 are mixed to give a component.

TABLE 5

| Component | Parts by wt. |
|---|---|
| V polymer 1200 A | 700 |
| Fumed Silica | 100 |
| Crosslinker 525 | 50 |
| Pt catalyst | 0.1 |
| Inhibitor | 0.2 |
| Cavamax W8 | 200 |
| cyclodextrin | |

### EXAMPLE 6

The constituents given in Table 6 are mixed, and in each case a component A and B is prepared. The components A and B obtained are then mixed in the ratio 1:1.

TABLE 6

| Component A | Parts by wt. | Component B | Parts by wt. |
|---|---|---|---|
| Vi polymer 20 000 | 400 | Vi polymer 20 000 | 400 |
| Fumed Silica | 50 | Fumed Silica | 50 |
| Pt catalyst | 0.4 | Crosslinker 525 | 1.5 |
| Inhibitor | 0.4 | | |
| Cavasol W8 modified | 40 | Cavasol W8 | 40 |
| cyclodextrin | | modified | |
| | | cyclodextrin | |

### EXAMPLE 7

The constituents given in Table 7 are mixed to give a component.

TABLE 7

| Component | Parts by wt. |
|---|---|
| V polymer 1200 A | 700 |
| Fumed Silica | 100 |
| Crosslinker 525 | 50 |
| Pt catalyst | 0.1 |
| Inhibitor | 0.2 |
| Cavamax W8 | 200 |
| cyclodextrin | |

The mixture from Example 5 or 7 or the combined mixture of the two components from Example 6 is processed in an injection molding or compression molding process typical for these substances to give molded sections. These molded sections are joined to the cork stopper in a suitable way, for example, by fixing with a silicone adhesive, by mechanical fixing, or by a combination of the two.

Also, the mixture from Example 5 or 7 or the combined mixture of the two components from Example 6 can be mixed with pieces of cork and this composition can be processed by means of vulcanization of the silicone in an injection molding or compression molding process typical for these substances to give closure stoppers.

### EXAMPLE 8

The constituents given in Table 8 are mixed, and in each case a component A and B is prepared. The resulting components A and B are then mixed in the ratio 10:1. The constituents given in Table 8 are mixed to give a component.

TABLE 8

| Component A | Parts by wt. | Component B | Parts by wt. |
|---|---|---|---|
| OH polymer 20,000 | 400 | Vi polymer 20,000 | 400 |
| Fumed Silica | 20 | Sn catalyst | 2.4 |
| Metal oxides | 100 | Alkoxy crosslinker | 20 |
| Water | 0.4 | | |
| Cavamax W8 | 100 | Cavamax W8 | 100 |
| cyclodextrin | | cyclodextrin | |

### EXAMPLE 9

The constituents given in Table 9 are mixed to give a component.

TABLE 9

| Component | Parts by wt. |
|---|---|
| OH polymer 20,000 | 500 |
| Fumed Silica | 50 |
| Metal oxides | 50 |
| ES 15 | 10 |
| Ti(BuO)₄ | 0.4 |
| Cavsol W6 modified | 80 |
| cyclodextrin | |

The combined mixture of the two components from Example 8 or the mixture from Example 9 is applied to the front end of a cork subsequently to be directed toward wine such that the cork itself can have no or only slight direct contact with the wine. In order to make available an adequately large amount of silicone for the absorption of the TCA, an indentation is preferably made into the front side of the cork before applying the silicone. The vulcanisate preferably forms a mechanical anchoring within the stopper.

Silicones of the above mixtures from Example 8 and Example 9 can also be applied one after the other and thus combined with one another.

### EXAMPLE 10

Comparison of the effectiveness of the trichloroanisole (“TCA”) absorption of an elastomer and of a CD-containing elastomer.

The silicone:wine quantitative ratio for a cork coated with 0.5-1.0 g of silicone in a 0.7 l bottle of wine is about 1:1000. 0.1 g of silicone vulcanisates according to Examples 1 to 4 were therefore placed into 100 ml of 12% strength ethanol which had an initial TCA concentration of 0.2 ppm:, and the fraction of TCA remaining in the ethanol solution was determined at various intervals.

Table 10 shows, by way of example, the results of one of the silicone vulcanisates in which, additionally, the CD content was also varied as stated.

TABLE 10

| No. | Cyclodextrin in | Fraction of TCA remaining in the solution in % | | | | | |
|---|---|---|---|---|---|---|---|
| 1 | the vulcanisate | 1 d | 3 d | 7 d | 14 d | 21 d | 28 d |
| 1 | 23% | 50% | 40% | 20% | 15% | 5% | 5% |
| 2 | 10% | 75% | 30% | 20% | 20% | 15% | 15% |
| 3 | 2% | 70% | 35% | 30% | 35% | 35% | 30% |
| 4 | 0% | 75% | 70% | 60% | 60% | 60% | 60% |

A CD-free silicone vulcanisate (prior art) absorbs approximately 40% of the TCA originally dissolved in the ethanol within 1 week. This 40:60 distribution: (TCA in the silicone): (TCA in 12% by weight aqueous ethanol) is largely dependent on the nature of the silicone chosen. Only as a result of the addition according to the invention of a cyclodextrin is a significant shift in the equilibrium toward the silicone vulcanisate achieved.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A cork-containing bottle stopper with a surface which is provided with a polymer coating, wherein the polymer comprises at least one cyclodextrin selected from the group consisting of α-, β-, and γ-cyclodextrin and α-, β-, or γ-cyclodextrin derivatives.

2. The bottle stopper of claim 1, wherein the polymer comprises 0.01 to 40% by weight of cyclodextrin.

3. The bottle stopper of claim 1, wherein the polymer comprises 10 to 25% by weight of cyclodextrin.

4. The bottle stopper of claim 1, wherein the polymer contains at least one of uncomplexed α-, β-, or γ-cyclodextrin.

5. The bottle stopper of claim 1, wherein the polymer contains uncomplexed γ-cyclodextrin.

6. The bottle stopper of claim 1, wherein the polymer comprises an elastomer derived from a crosslinkable silicone rubber composition comprising
A)
(1) organopolysiloxanes (1) bearing radicals with aliphatic carbon-carbon multiple bonds,
(2) at least one organopolysiloxane bearomg Si-bonded hydrogen,
(3) a catalyst which promotes addition of Si-bonded hydrogen onto aliphatic multiple bonds,
(4) optionally, inhibitors which delay the addition of Si-bonded hydrogen onto aliphatic multiple bonds,
B)
(5) at least one organopolysiloxane (1) bearing radicals with aliphatic carbon-carbon multiple bonds, and
(6) peroxide(s) which promote the free-radical crosslinking of aliphatic multiple and single bonds,
C)
(7) organopolysiloxane(s) which bear radicals with hydroxyl groups,
(8) as crosslinker(s) siloxane(s) with Si-bonded, hydrolyzable groups, and
(9) catalyst(s) which promote the hydrolysis of hydrolyzable groups with the formation of Si—O—Si bridges.

7. The bottle stopper of claim 6, wherein the elastomer is derived from a crosslinkable silicone rubber composition comprising, as organopolysiloxane(s) (1) or (5), those of the formula
R¹_{g}R_{3-g}SiO(SiR₂O)ₙ(SiRR¹O)ₘSiR_{3-g}R¹_{g} (II)
where R each is identical or different, and is a monovalent, optionally halogenated hydrocarbon radical having 1 to 18 carbon atom(s) per radical, and
R¹ each is identical or different, and is a monovalent hydrocarbon radical with a terminal, aliphatic carbon-carbon multiple bond having 2 to 8 carbon atoms per radical,
g is 0, 1, 2 or 3,
m is 0 or an integer from 1 to 5000 and
n is an integer from 70 to 10 000,
with the proviso that the organopolysiloxanes of the formula (II) comprise at least 2 radicals R¹ per molecule.

8. The bottle stopper of claim 6, wherein the elastomer is derived from a crosslinkable silicone rubber composition comprising, as organopolysiloxane(s) (2), those of the formula
HₕR₃₋ₕSiO(SiR₂O)ₒ(SiR₂₋ₓHₓO)ₚSiR₃₋ₕHₕ (IV)
where
h is 0, 1 or 2,
o is 0 or an integer from 1 to 1000,
p is an integer from 1 to 1000 and
x is 1 or 2.

9. The bottle stopper of claim 6, wherein the elastomer is derived from a crosslinkable silicone rubber composition comprising, as organopolysiloxane(s) (7), those of the formula
XR₂SiO(R₂SiO)ₙSiR₂X (V)
where R each is an identical or different, monovalent, optionally substituted hydrocarbon radical having 1 to 18 carbon atoms per radical,
X is a hydroxyl group and
n is an integer of at least 10.

10. The bottle stopper of claim 6, wherein the elastomer is derived from a crosslinkable silicone rubber composition comprising, as crosslinkers (8), moisture-sensitive silanes of the formula
RₓSiZ₄₋ₓ
and/or partial hydrolysates thereof where R has the meaning given for it above,
x is 0 or 1 and
Z each is an identical or different hydrolyzable radical selected from the group consisting of acyloxy, optionally substituted hydrocarbonoxy, amino, oxime, amide, amineoxy and eneoxy radicals.

11. The bottle stopper of claim 10, wherein the hydrolysates have from 2 to 10 silicon atoms.

12. A method of producing a bottle stopper of claim 1, comprising applying to a bottle cork a flowable, addition-crosslinking silicone rubber composition containing said cyclodextrin, and removing excess silicone rubber composition from the bottle cork, and crosslinking the silicone rubber composition remaining on the bottle cork.

13. A method of producing a bottle stopper of claim 1, comprising molding an addition-crosslinking silicone containing said cyclodextrin by means of press vulcanization to a round molded article, and fixing the molded article onto the end of a bottle cork with an adhesive.

14. A method of producing a bottle stopper of claim 1, comprising molding a pasty, addition-crosslinking silicone containing said cyclodextrin by press vulcanization to a round molded article in an injection molding process, and fixing the molded article onto the end of a bottle cork with an adhesive.

15. A method of producing a bottle stopper of claim 1, comprising applying a two-component condensation-crosslinking silicone containing said cyclodextrin to at least the end of a bottle cork and curing and adhering the silicon directly on the bottle cork.

16. A method of producing a bottle stopper of claim 1, comprising applying a one-component condensation-crosslinking silicone containing said cyclodextrin to the end of a bottle cork and curing and adhering the silicone directly on the bottle cork.

17. A method of producing a bottle stopper of claim 1, comprising spraying a cork with a silicone containing said cyclodextrin while rotating in a closed drum, thereby wetting the cork on its surface, and curing the silicone.

18. A method of producing a bottle stopper of claim 1, comprising mixing cork pieces with a moldable cyclodextrin-containing polymer, and molding to form a composite stopper.
